(19) United States
(12) Patent Application Publication
(10) Pub. No.: US 2024/0361208 A1
(43) Pub. Date: Oct. 31, 2024

(54) DEVICE FOR COLLECTING AND SUCKING OFF CLIPPINGS AND MICROTOME

(71) Applicant: PFM MEDICAL AG, Köln (DE)

(72) Inventors: Steffen KRAUS, Sandhausen (DE); Erwin SCHNEIDER, Nußloch (DE)

(21) Appl. No.: 18/580,949

(22) PCT Filed: Jul. 20, 2022
(86) PCT No.: PCT/DE2022/200162

§ 371 Date: Jan. 19, 2024

(30) Foreign Application Priority Data
Jul. 21, 2021 (DE) 10 2021 207 805.2

(51) Int. Cl. G01N 1/06; G01N 1/34

(52) U.S. Cl. CPC G01N 1/06; G01N 1/34; G01N 2001/061

(57) ABSTRACT

A device for collecting and sucking off clippings, in particular embedding medium, for example paraffin, on a microtome (1), in particular a rotary microtome, having at least one connecting element (12) for form-fitting and/or force-fitting attachment to the microtome (1) and a collecting tray (3) forming a collecting area, wherein an suction opening (4) for sucking off the clippings is formed on the collecting tray (3). Furthermore, a system with such a device, a microtome (1) and a work table (2) is disclosed.

The invention relates to a device for collecting and sucking off clippings, in particular embedding medium, for example paraffin, from a microtome, in particular a rotary microtome.

The invention also relates to a microtome, in particular a rotary microtome.

Microtomes are devices for producing extremely thin sections and are used in medicine or biology, for example, to examine tissue samples under a microscope. In order to be able to cut the tissue samples, they must first be fixed and embedded. During embedding, the tissue samples are enclosed in a liquid embedding medium, such as paraffin, which then hardens. The appropriately prepared sample can then be cut with the microtome.

Such a rotary microtome is described, for example, in DE 10 2011 112 450 A1. When the microtome is used, clippings is produced, a large proportion of which consists of the embedding medium. To collect the clippings, it is known to arrange clipping trays in the area of the blade holder or the sample holder. However, the problem here is that the clipping trays are often too small. Another problem is the laborious emptying and cleaning of the clipping trays.

The present invention is therefore based on the problem of providing a device for collecting clippings which is suitable for receiving large quantities of waste and is also easy to empty and clean. Furthermore, a microtome with such a device is to be disclosed. Furthermore, a system with a microtome and a receptacle for the microtome is to be disclosed.

According to the invention, the above problem is solved by the features of claim 1. A device for collecting and sucking off clippings, in particular embedding medium, for example paraffin, on a microtome, in particular a rotary microtome, is thus specified, having at least one connecting element for form-fitting and/or force-fitting attachment to the microtome and a collecting tray forming a collecting region, a suction opening for sucking off the clippings being formed on the collecting tray.

With regard to the microtome, the underlying problem is solved by the features of claim 10. According to this claim, a microtome, in particular a rotary microtome, has a device for collecting and sucking off clippings according to one of claims 1 to 9.

In accordance with the invention, it has been recognized that the disposal of clippings is considerably simplified if a suction opening for suctioning off the clippings is formed on the collection tray. In this way, cleaning can be essentially automated, namely by sucking the clippings through the suction opening continuously or at intervals. Manual emptying or cleaning of the collection tray is therefore no longer necessary, so that there is no need to interrupt the use of the microtome to empty the clippings.

In an advantageous manner, a suction device can be arranged which is connected to the suction opening via a suction channel. The suction device is used to extract the clippings from the collection tray. For this purpose, the suction device can have a pump that generates a sufficiently high vacuum to be able to suck in the clippings.

In a further advantageous manner, the suction device can have a power control via which the suction power can be regulated. Specifically, this can be a speed control of a suction pump. The power control can be implemented via a control/regulation unit, for example a microcontroller or a computer. It is also conceivable that parameters of the microtome, for example the number of cuts, the number of cuts per time unit, are taken into account in the power control. Alternatively or additionally, a control panel can be provided via which the power of the suction device can be adjusted.

According to a preferred embodiment, the suction channel can be designed as a suction hose. Such a design is particularly easy to manufacture and ensures reliable operation.

According to a further advantageous variant, the suction channel or the suction hose can be detachably attached to the suction opening. In the event of a blockage or other malfunction, the suction hose can be removed and the fault rectified. Specifically, the suction channel or suction hose could have a latching means for this purpose, which can be fixed to a complementary latching receptacle on the suction opening. This allows the suction channel or suction hose to be clipped onto the suction opening. Other fastening means are conceivable, for example a plug-in connection, a screw connection or a bayonet connection.

In an advantageous manner, two connecting elements can be provided, whereby the connecting elements are each designed as connecting legs. The connecting legs make it possible to attach the device to the microtome in the area of the knife holder by extending the connecting legs to the side of the knife holder. It is also conceivable that the connecting legs can be clamped to the microtome in the area of the knife holder using screws or quick-release clamps.

In a further advantageous manner, the collection area can extend beyond the connecting element or elements. In this way, clippings falling from the side of the blade holder can also reach the collection area and be disposed of through the discharge opening.

In a particularly advantageous manner, at least one latching element can be arranged for positive connection with the microtome, for example on the collection tray. The latching element can, for example, have an elastic latching nose which can be clicked or snapped into a complementary structure of the microtome. In concrete terms, it is conceivable that the device is first clicked onto the microtome via the latching element and can then be clamped to the microtome using screws or quick-release clamps.

The underlying problem is further solved by claim 11. Accordingly, a system has a microtome according to claim 10 and a, preferably height-adjustable, laboratory table.

The system provides an ergonomic workstation that makes it comfortable to work with the microtome. The laboratory table can advantageously be made of stainless steel or a similarly stable and easy-to-clean material.

In an advantageous way, an opening or a cut-out for the suction channel, in particular for a suction hose, can be provided on the laboratory table.

There are now various possibilities for advantageously designing and further developing the teaching of the present invention. For this purpose, reference should be made, on the one hand, to the claims following claim 1 and, on the other hand, to the following explanation of preferred embodiments of the invention with reference to the drawing. In connection with the explanation of the preferred embodiments of the invention with reference to the drawing, generally preferred embodiments and further embodiments of the teaching are also explained. The drawing show

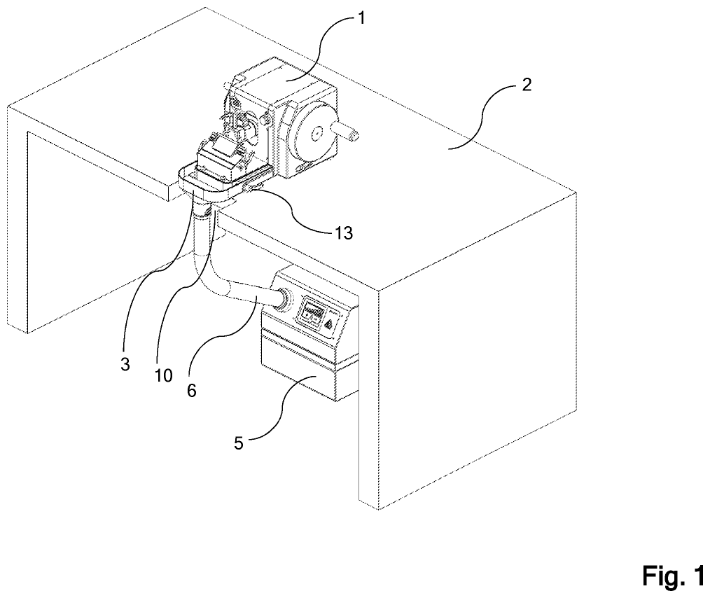

FIG. 1 a schematic representation of a system according to the invention,

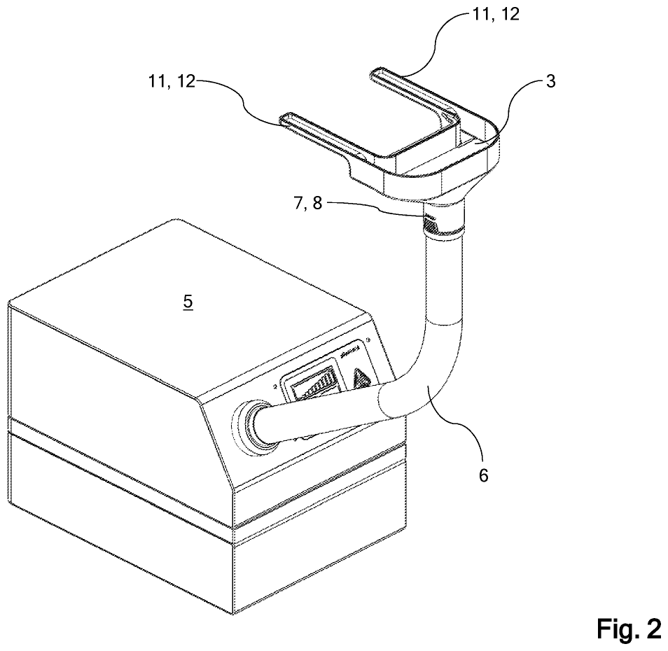

FIG. 2 a schematic representation of the device shown in FIG. 1,

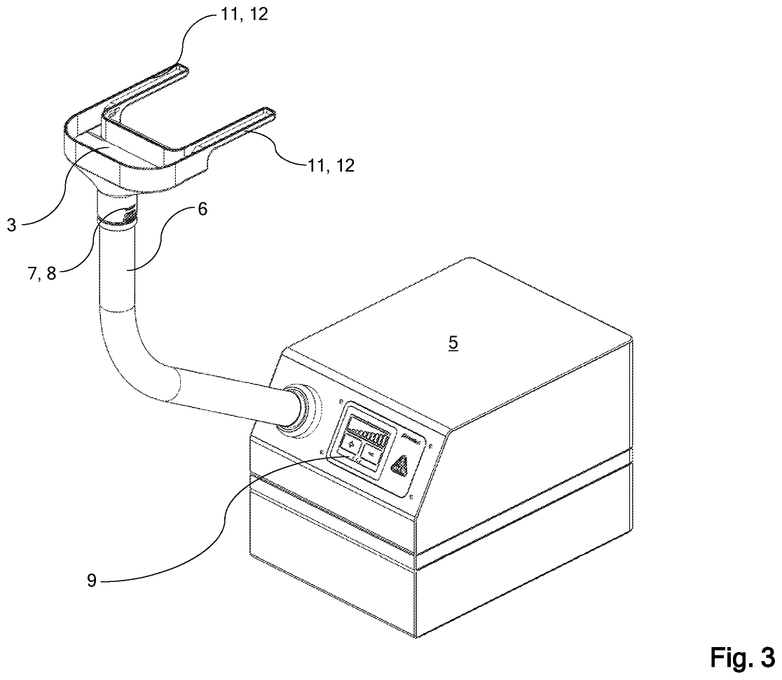

FIG. 3 a further schematic representation of the device shown in FIG. 1,

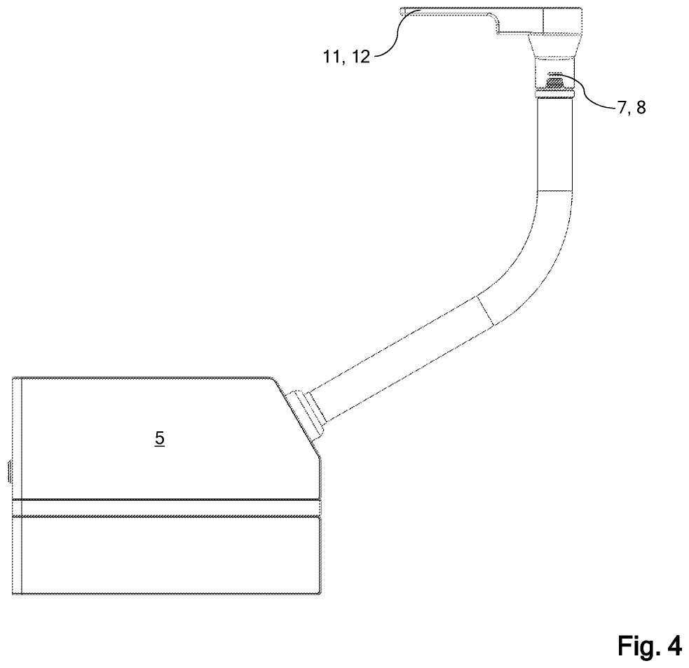

FIG. 4 a further schematic representation of the device shown in FIG. 1,

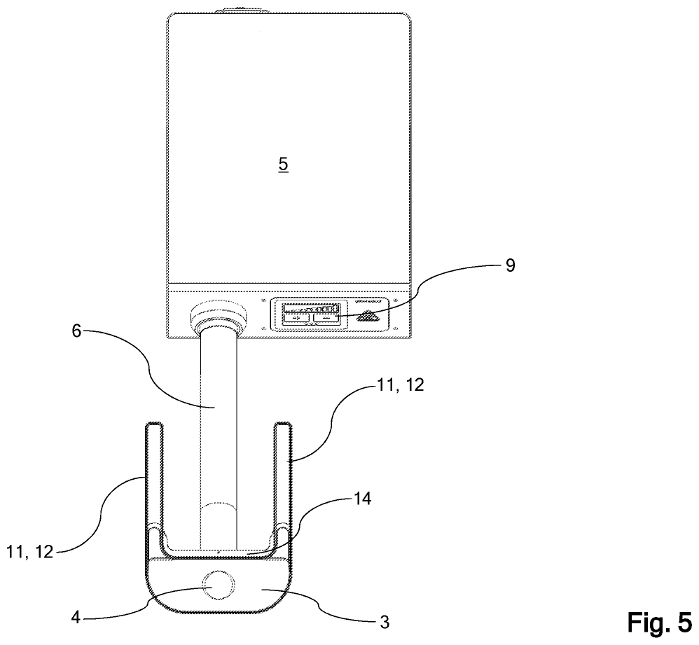

FIG. 5 a further schematic representation of the device according to FIG. 1, and

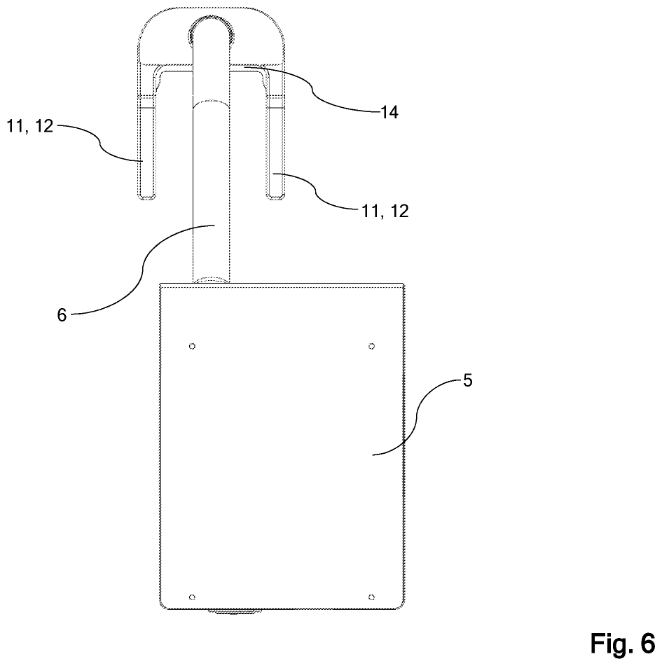

FIG. 6 a further schematic representation of the device shown in FIG. 1.

FIGS. 1 to 6 show an embodiment of a system according to the invention and a device according to the invention. To improve clarity, not all elements in the figures are always provided with a reference sign, whereby identical elements in the figures have the same reference signs.

The system shown in FIGS. 1 and 2 has a microtome 1 designed as a rotary microtome, a device for collecting and sucking off clippings and a work table 2.

The device for collecting and sucking off clippings has a collection tray 3, which forms a collection area for the clippings. A suction opening 4 is formed on or in the collecting tray 3, through which the clippings can be sucked off. For this purpose, a suction device 5 is flow-connected to a suction channel 6 designed as a suction hose.

The suction hose has a latching means 7, which can be fixed to a complementary latching receptacle 8 on the suction opening 4. This snap-in connection or click connection allows the suction hose to be easily connected to and disconnected from the suction opening 4. The suction device 5 can, for example, have a pump that is used to generate a vacuum in order to suck up the clippings. The suction device 5 can have a power control, for example a speed control. Furthermore, a control panel 9 is arranged, via which the power and/or other parameters of the suction device 5 can be set.

The work table 2 has a cut-out 10 for the suction hose so that the suction device 5 can be positioned underneath the work table 2 and does not take up any space in the actual work area. The work table 2 can also be height-adjustable to enable ergonomic working. Alternatively or additionally, the work table 2, at least its work surface, can be made of stainless steel or another easy-to-clean and stable material.

The figures also show that two connecting elements 12 in the form of connecting legs 11 are provided. The holding area extends over the connecting legs 11, so that the blade holder of the microtome 1 is surrounded on three sides by the holding area in order to hold clippings.

In the embodiment example shown here, the connecting legs 11 are clamped to the microtome 1 via quick-release clamps 13. Furthermore, latching elements-not shown here-can be arranged which, for example, have latching lugs with which they can engage on a complementary structure of the microtome 1. This can create a click connection or snap connection between the device and the microtome 1, for example before the device is clamped to the microtome 1 via the quick-release clamps 13.

FIGS. 5 and 6 in particular also show that an edge 14 is formed on the side of the collection tray 3 facing the microtome 1. This reinforces the collection tray 3. Furthermore, the edge 14 can serve as a positioning aid for the device in relation to the microtome 1.

With regard to further advantageous embodiments of the device according to the invention, reference is made to the general part of the description and to the appended claims in order to avoid repetition.

Finally, it should be expressly pointed out that the above-described embodiments of the device according to the invention serve only to discuss the claimed teaching, but do not limit it to the embodiments.

### LIST OF REFERENCE NUMERALS

1 microtome
2 Work table
3 Collecting tray
4 Suction opening
5 Suction device
6 Suction duct
7 Latching means
8 latching receptacle
9 Control panel
10 Cutout
11 Connecting leg
12 Connecting element

1. Device for collecting and sucking off clippings, in particular embedding medium, for example paraffin, on a microtome (1), in particular a rotary microtome, having at least one connecting element (12) for form-fitting and/or force-fitting attachment to the microtome (1) and a collecting tray (3) forming a collecting area, wherein a suction opening (4) for sucking off the clippings being formed on the collecting tray (3).

2. Device according to claim 1, characterized in that a suction device (5) is arranged, which is flow-connected to the suction opening (4) via a suction channel (6).

3. Device according to claim 1 or 2, characterized in that the suction device (5) has a power control, in particular a speed control.

4. Device according to one of claims 1 to 3, characterized in that the suction channel (6) is designed as a suction hose.

5. Device according to one of claims 2 to 4, characterized in that the suction channel (6), in particular the suction hose, is detachably fixed to the suction opening (4).

6. Device according to one of claims 1 to 5, characterized in that the suction channel (6), in particular the suction hose, has a latching means (7) which can be fixed to a complementary latching receptacle (8) on the suction opening (4).

7. Device according to one of claims 1 to 6, characterized in that two connecting elements (12) are provided, wherein the connecting elements (12) each being designed as connecting legs (11).

8. Device according to one of claims 1 to 7, characterized in that the collecting area extends beyond the connecting element (12) or the connecting elements (12).

9. Device according to one of claims 1 to 8, in that at least one latching element is arranged for positive connection to the microtome (1).

10. Microtome (1), in particular rotary microtome, with a device for collecting and sucking off clippings according to one of claims 1 to 9.

11. System with a, preferably height-adjustable, work table (2) and a microtome (1), in particular a rotary microtome, according to one of claims 1 to 10.
